(19) United States
(12) Patent Application Publication
(10) Pub. No.: US 2015/0133588 A1
(43) Pub. Date: May 14, 2015

(54) POLYMER COMPOSITION CONTAINING ORGANIC NONLINEAR OPTICAL COMPOUND

(71) Applicants: KYUSHU UNIVERSITY, Fukuoka-shi, Fukuoka (JP); NISSAN CHEMICAL INDUSTRIES, LTD., Tokyo (JP)

(72) Inventors: Shiyoshi Yokoyama, Fukuoka-shi (JP); Kazuhiro Yamamoto, Fukuoka-shi (JP); Andrew Mark Spring, Fukuoka-shi (JP); Daisuke Maeda, Funabashi-shi (JP); Masaaki Ozawa, Funabashi-shi (JP); Keisuke Odoi, Tokyo (JP)

(21) Appl. No.: 14/401,302

(22) PCT Filed: May 14, 2013
(86) PCT No.: PCT/JP2013/063416

§ 371 Date: Nov. 14, 2014

(30) Foreign Application Priority Data
May 14, 2012 (JP) 2012-111048

(51) Int. Cl. C08K 5/548; G02F 1/361; C09D 179/08

(52) U.S. Cl. CPC C08K 5/548; C09D 179/08; G02F 1/3614
USPC 524/84

(57) ABSTRACT

There is provided a polymer matrix that can suppress the orientational relaxation of an organic nonlinear optical compound, and a composition containing this polymer matrix and an organic nonlinear optical compound, and an optical material obtained by using the composition. A composition including: a norbornene imide polymer having a structural unit of Formula [1]; and an organic nonlinear optical compound:

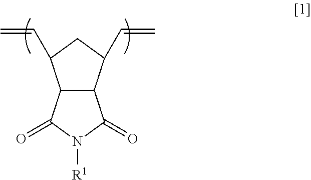

(where R¹ is a C₁₋₁₂ alkyl group optionally having a substituent or a C₆₋₁₀ aryl group optionally having a substituent).

### TECHNICAL FIELD

The present invention relates to a polymer composition containing an organic nonlinear optical compound that is used for, for example, optical information processing such as optical switches and light modulation, and optical communications. Specifically, the present invention relates to a composition in which the organic nonlinear optical compound is dispersed in a polymer matrix and to an optical material formed from the composition.

### BACKGROUND ART

In the technical fields of, for example, optical information processing and optical communications, various photoelectric devices using materials containing fluorescent dyes or nonlinear optical materials have been developed in recent years. Among these, the nonlinear optical materials are materials that show a polarization response proportional to the second, the third, or a higher-order term of the electric field of light. Application of the nonlinear optical materials having second-order nonlinear optical effects such as second-harmonic generation (SHG) and the Pockels effect, which is a linear electro-optic effect, to light sources, optical switches, and light modulation, for example, is considered.

Lithium niobate and potassium dihydrogenphosphate have been commercialized as inorganic nonlinear optical materials and widely used. However, recently, attention is being given to organic nonlinear optical materials that have superiority such as high nonlinear optical performance, low material costs, and high mass productivity over these inorganic materials. Research and development on the organic nonlinear optical materials have been actively conducted toward commercialization.

Known methods for manufacturing a device using an organic material include a method using a single crystal of a compound (nonlinear optical compound) having nonlinear optical characteristics, an evaporation method, and an LB film method. Also known are a method in which a structure having nonlinear optical characteristics is introduced into a main chain or a side chain of a polymer compound, a method in which a nonlinear optical compound is dispersed in a polymer matrix, and other methods. In particular, polymers are readily processed because they can be formed into films by casting, a dip method, spin coating, or similar methods.

Among these methods, the method in which a nonlinear optical compound is dispersed in a polymer matrix requires that the nonlinear optical compound be dispersed at a high concentration without flocculation and be optically uniform.

As such a nonlinear optical compound to be used in the method, a push-pull π-conjugated compound is known that has a n-conjugated chain one end of which is an electron donative functional group and the other end of which is an electron attractive functional group. Examples thereof include Disperse Red 1 (DR1) in which azobenzene as a π-conjugated chain has a diethylamino group as an electron donative group and a nitro group as an electron attractive group.

Such molecules, however, have large dipole moment, thus cause a strong intermolecular interaction, and have low solubility or dispersibility in a medium. It has thus been difficult to disperse the molecules in poly(methyl methacrylate) (PMMA), which is typically used as a polymer matrix, or other mediums at a high concentration. In addition, because the glass transition temperature of PMMA is low, about 100° C., the orientation of an organic nonlinear optical compound with which PMMA is used as a polymer matrix is gradually relaxed even at room temperature, and the characteristics of the compound deteriorate with time.

On this account, a search for a polymer matrix as an alternative to PMMA has been made vigorously. The use of a polymer having a high glass transition temperature, such as a polycarbonate, a polyimide, and a polysulfone has been described (Patent Document 1).

Although the use of a polymer matrix other than PMMA has been studied in various ways, as described above, compatibility between such a polymer matrix and a nonlinear optical compound such as DR1 is also far from the best. Specifically, when a nonlinear optical compound is added at a high concentration in order to enhance nonlinear optical characteristics, the compound may be flocculated or crystallized disadvantageously. Alternatively, even when a nonlinear optical compound is added at a low concentration, the compound may be flocculated or crystallized disadvantageously due to heat application or the passage of time.

For this reason, a polymer matrix has been described that is a specific branched polymer compound having a biphenylene structure, in other words, a hyperbranched polymer (Patent Document 2). The use of this polymer matrix enables functional dyes such as fluorescent dyes and nonlinear optical dyes to be optically dispersed uniformly at a high concentration.

Furthermore, a norbornene imide polymer is known as a polymer having a high glass transition temperature and high transparency (Non-Patent Document 1).

### PRIOR ART DOCUMENTS

### Patent Documents

Patent Document 1: Japanese Patent Application Publication No. H06-202177 (JP 1106-202177 A)
Patent Document 2: Japanese Patent Application Publication No. 2010-139994 (JP 2010-139994 A)

### Non-Patent Document

Non-Patent Document 1: Macromol. Chem. Phys. 2002, 203, 1811

### DISCLOSURE OF THE INVENTION

### Problem to be Solved by the Invention

Although various types of polymer matrices have been disclosed as described above, there are still needs for a polymer matrix that can suppress the orientational relaxation of an organic nonlinear optical compound.

An object of the present invention is to provide a polymer matrix that can suppress the orientational relaxation of an organic nonlinear optical compound, and a composition containing this polymer matrix and an organic nonlinear optical compound, and an optical material obtained by using the composition.

### Means for Solving the Problem

As a result of repeated intensive studies to achieve the objects described above, the inventors of the present invention have found that the orientational relaxation of an organic nonlinear optical compound can be suppressed by a combined use of a norbornene imide polymer having a specific unit structure and the organic nonlinear optical compound. The inventors thus completed the present invention.

Specifically, the present invention relates to, as a first aspect, a composition comprising: a norbornene imide polymer having a structural unit of Formula [1]; and an organic nonlinear optical compound:

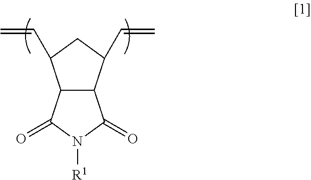

(where R¹ is a C₁₋₁₂ alkyl group optionally having a substituent or a C₆₋₁₀ aryl group optionally having a substituent).

The present invention relates to, as a second aspect, the composition according to the first aspect, in which the organic nonlinear optical compound is a compound having a furan ring of Formula [2]:

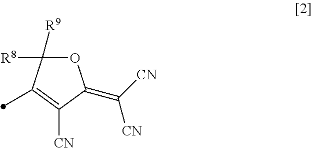

(where R⁸ and R⁹ are each independently a hydrogen atom, a C₁₋₅ alkyl group, a C₁₋₅ haloalkyl group, or a C₆₋₁₀ aryl group; and • is a bond).

The present invention relates to, as a third aspect, the composition according to the second aspect, in which the organic nonlinear optical compound is a compound of Formula [3]:

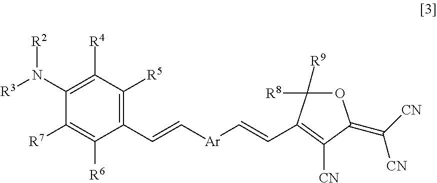

(where R² and R³ are each independently a hydrogen atom, a C₁₋₁₀ alkyl group optionally having a substituent, or a C₆₋₁₀ aryl group optionally having a substituent; R⁴ to R⁷ are each independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group, or a halogen atom; R⁸ and R⁹ are each independently a hydrogen atom, a C₁₋₅ alkyl group, a C₁₋₅ haloalkyl group, or a C₆₋₁₀ aryl group; and Ar is a bivalent organic group of Formula [4] or [5]):

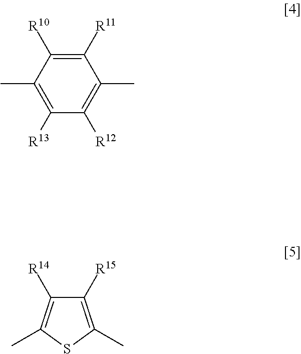

(where R¹⁰ to R¹⁵ are each independently a hydrogen atom, a C₁₋₁₀ alkyl group optionally having a substituent, or a C₆₋₁₀ aryl group optionally having a substituent).

The present invention relates to, as a fourth aspect, the composition according to any one of the first to the third aspects, in which the content of the organic nonlinear optical compound is 1 to 150 parts by mass per 100 parts by mass of the norbornene imide polymer.

The present invention relates to, as a fifth aspect, a varnish comprising: the composition as described in any one of the first to the fourth aspects.

The present invention relates to, as a sixth aspect, a thin film made from the varnish as described in the fifth aspect.

The present invention relates to, as a seventh aspect, an electro-optical element comprising: the composition as described in any one of the first to the fourth aspects.

The present invention relates to, as an eighth aspect, an optical switching element comprising: the composition as described in any one of the first to the fourth aspects.

The present invention relates to, as a ninth aspect, an organic nonlinear optical material comprising: the composition as described in any one of the first to the fourth aspects.

### Effects of the Invention

The composition of the present invention enables the orientational relaxation of an organic nonlinear optical compound to be suppressed by a combined use of a norbornene imide polymer having a specific unit structure and the organic nonlinear optical compound.

The composition of the present invention can be dissolved in a solvent to be a varnish form and thus can be readily formed. This allows the composition to have an effect of being suitably used in photoelectric material fields as an optical material with high handling ability.

Furthermore, the organic nonlinear optical material of the present invention has a large nonlinear optical constant, and an optical device with easy formability can be produced with the material.

### BRIEF DESCRIPTION OF THE DRAWINGS

FIG. 1 is a graph showing a ¹H NMR spectrum of N-cyclohexyl-exo-norbornene-5,6-dicarboximide produced in Synthesis Example 3.

FIG. 2 is a graph showing a result of a temperature endurance test in Example 3.

### MODES FOR CARRYING OUT THE INVENTION

The composition of the present invention is a composition comprising a norbornene imide polymer having a structural unit of Formula [1], and an organic nonlinear optical compound.

The present invention will be described in more detail.

<Norbornene Imide Polymer Having Structural Unit of Formula [1]>

The average molecular weight of the norbornene imide polymer having the structural unit of Formula [1], used in the present invention, is not particularly limited but is preferably a weight-average molecular weight of 10,000 to 1,000,000.

The weight-average molecular weight in the present invention means a measurement value obtained by gel permeation chromatography (in terms of polystyrene),

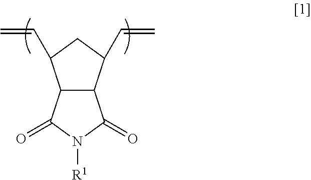

In Formula [1], R¹ is a C₁₋₁₂ alkyl group optionally having a substituent or a C₆₋₁₀ aryl group optionally having a substituent.

The C₁₋₁₂ alkyl group may have a branched or ring structure. Examples thereof include a methyl group, an ethyl group, an n-propyl group, an isopropyl group, a cyclopropyl group, an n-butyl group, an isobutyl group, a sec-butyl group, a tert-butyl group, an n-pentyl group, a neopentyl group, a cyclopentyl group, an n-hexyl group, a cyclohexyl group, an n-octyl group, an n-decyl group, an n-dodecyl group, a 1-adamantyl group, a benzyl group, and a phenethyl group.

Examples of the C₆₋₁₀ aryl group include a phenyl group and a naphthyl group.

Examples of the substituent of the C₁₋₁₂ alkyl group include a hydroxy group; and a halogen atom such as a fluoro group, a chloro group, a bromo group, and an iodo group.

Examples of the substituent of the C₆₋₁₀ aryl group include an alkyl group such as a methyl group and an ethyl group; a hydroxyalkyl group such as a hydroxymethyl group; a hydroxy group; an alkoxy group such as a methoxy group and an octyloxy group; and a halogen atom such as a fluoro group, a chloro group, a bromo group, and an iodo group.

Specific examples of R¹ include a cyclohexyl group, a 4-hydroxycyclohexyl group, an n-octyl group, a 1-adamantyl group, a phenyl group, a 4-tolyl group, a 4-hydroxymethylphenyl group, a 4-hydroxyphenyl group, and a 2,3,4,5,6-pentafluorophenyl group.

The structural unit of Formula [1] may be a cis form or a trans form.

The norbornene imide polymer used in the present invention is a norbornene imide polymer having the structural unit of Formula [1] and may have another structural unit in addition to the structural unit of Formula [1]. Examples of the other structural unit include structural units of norbornene, cyclobutene, cyclopentene, cyclooctene, cyclododecene, and 1,5-cyclooctadiene. When the norbornene imide polymer has the other structural unit, the proportion of the structural unit of Formula [1] is desirably 50% by mole to 99% by mole to all of the polymers.

However, the norbornene imide polymer is preferably a polymer consisting of only the structural unit of Formula [1] because the effects of the present invention are easily obtained. Thus, the norbornene imide polymer used in the present invention desirably has the structural unit of Formula [1] in a proportion of 50% by mole to 100% by mole.

<Method for Producing Norbornene Imide Polymer Having Structural Unit of Formula [1]>

The norbornene imide polymer having the structural unit of Formula [1] is obtained by, for example, causing a polymerization reaction of norbornene imide monomers in a solvent in the presence of a metal complex such as a ruthenium catalyst.

The norbornene imide polymer can be synthesized according to the description in Macromol. Chem. Phys. 2002, 203, 1811 to 1818.

In the production of the norbornene imide polymer having the structural unit of Formula [1], norbornene imide monomers may be used alone or two or more of them may be used in combination. When two or more of them are used, the ratio of each of the monomers is not particularly limited and may be adjusted as appropriate depending on a target polymer structure.

As described above, the norbornene imide polymer having the structural unit of Formula [1] may have a structural unit (of norbornene, cyclobutene, cyclopentene, cyclooctene, cyclododecene, or 1,5-cyclooctadiene, for example) other than the structural unit of Formula [1]. In this case, a norbornene imide polymer can be produced by using, besides a norbornene imide monomer, a monomer having the structural unit other than the structural unit of Formula [1], as the other monomer.

In the use of the other monomer, the other monomer may be used within a range of 1% by mole to 50% by mole to all monomers used for producing the norbornene imide polymer having the structural unit of Formula [1] used in the present invention.

Such other monomers may also be used alone or two or more of them may also be used in any combination. The proportion(s) of the monomer(s) are not particularly limited and may be adjusted depending on a target norbornene imide polymer structure.

The metal complex to be used in the polymerization reaction is not particularly limited and can be appropriately selected from various known metal complexes for polymerization and be used. Among these, ruthenium catalysts such as Grubbs' catalysts (the first generation Grubbs' catalyst and the second generation Grubbs' catalyst) are preferable.

The usable molar ratio of the metal complex is 5×10⁻³ to 1×10⁻² times that of the monomer as the raw material.

The solvent used in the polymerization reaction is not particularly limited unless it inhibits the polymerization reaction. Examples thereof include halogenated hydrocarbons such as methylene chloride, chloroform, 1,2-dichloroethane, and chlorobenzene. The solvents may be used alone or two or more of them may be used as a mixture in any combination.

The temperature in the polymerization reaction is not particularly limited but is −50° C. to 100° C. and preferably −50° C. to 60° C. The pressure in the polymerization reaction is also not particularly limited but is typically normal pressure.

The time of the polymerization reaction varies depending on, for example, the type of monomers and metal complexes to be used, and the temperature and the pressure in the polymerization, but is 10 minutes to 10 hours and preferably 20 minutes to 5 hours.

After the completion of the polymerization reaction, the produced norbornene imide polymer is recovered by any method and, as needed, is subjected to aftertreatment such as washing. Examples of the method for recovering the norbornene imide polymer from the reaction solution include methods such as reprecipitation.

<Organic Nonlinear Optical Compound>

The organic nonlinear optical compound used in the present invention is a π-conjugated compound that has an electron donative group at one end of a π-conjugated chain and an electron attractive group at the other end, and desirably has a larger molecular hyperpolarizability β. Examples of the electron donative group include a dialkylamino group, and examples of the electron attractive group include a cyano group, a nitro group, and a fluoroalkyl group.

Among these, examples of the organic nonlinear optical compound used in the present invention include a compound having a furan ring of Formula [2]:

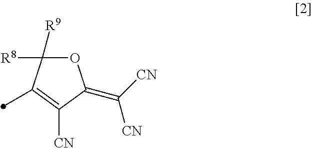

In the formula, R⁸ and R⁹ are each independently a hydrogen atom, a C₁₋₅ alkyl group, a C₁₋₅ haloalkyl group, or a C₆₋₁₀ aryl group, and • is a bond.

Specifically, the organic nonlinear optical compound is preferably a compound of Formula [3]:

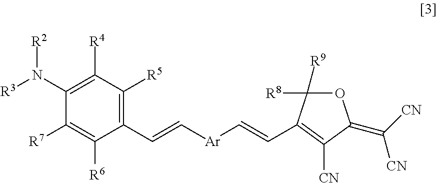

In Formula [3], R² and R³ are each independently a hydrogen atom, a C₁₋₁₀ alkyl group optionally having a substituent, or a C₆₋₁₀ aryl group optionally having a substituent.

The C₁₋₁₀ alkyl group may have a branched or ring structure. Examples thereof include a methyl group, an ethyl group, an n-propyl group, an isopropyl group, a cyclopropyl group, an n-butyl group, an isobutyl group, a sec-butyl group, a tert-butyl group, an n-pentyl group, a neopentyl group, a cyclopentyl group, an n-hexyl group, a cyclohexyl group, an n-octyl group, an n-decyl group, a 1-adamantyl group, a benzyl group, and a phenethyl group.

Examples of the C₆₋₁₀ aryl group include a phenyl group, a tolyl group, a xylyl group, and a naphthyl group.

Examples of the substituent include an amino group; a hydroxy group; an alkoxycarbonyl group such as a methoxycarbonyl group and a tert-butoxycarbonyl group; a silyloxy group such as a trimethylsilyloxy group, a tert-butyldimethylsilyloxy group, a tert-butyldiphenylsilyloxy group, and a triphenylsilyloxy group; and a halogen atom such as a fluoro group, a chloro group, a bromo group, and an iodo group.

In Formula [3], R⁴ to R⁷ are each independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group, or a halogen atom.

Examples of the C₁₋₁₀ alkyl group include the C₁₋₁₀ alkyl groups exemplified in the descriptions of R² and R³.

Examples of the C₁₋₁₀ alkoxy group include groups that are the above C₁₋₁₀ alkyl groups to be bonded via an oxygen atom.

Examples of the C₂₋₁₁ alkylcarbonyloxy group include groups that are the above C₁₋₁₀ alkyl groups to be bonded via a carbonyloxy group.

Examples of the C₄₋₁₀ aryloxy group include a phenoxy group, a naphthalen-2-yloxy group, a furan-3-yloxy group, and a thiophen-2-yloxy group.

Examples of the C₅₋₁₁ arylcarbonyloxy group include a benzoyloxy group, a 1-naphthoyloxy group, a furan-2-carbonyloxy group, and a thiophene-3-carbonyloxy group.

Examples of the silyloxy group having a C₁₋₆ allcyl group and/or a phenyl group include a trimethylsilyloxy group, a tert-butyldimethylsilyloxy group, a tert-butyldiphenylsilyloxy group, and a triphenylsilyloxy group.

Examples of the halogen atom include a fluoro group, a chloro group, a bromo group, and an iodo group.

In Formulae [2] and [3], R⁸ and R⁹ are each independently a hydrogen atom, a C₁₋₅ alkyl group, a C₁₋₅ haloalkyl group, or a C₆₋₁₀ aryl group.

The C₁₋₅ alkyl group may have a branched or ring structure. Examples thereof include a methyl group, an ethyl group, an n-propyl group, an isopropyl group, a cyclopropyl group, an n-butyl group, an isobutyl group, a sec-butyl group, a tert-butyl group, an n-pentyl group, a neopentyl group, and a cyclopentyl group.

Examples of the C₁₋₅ haloalkyl group may have a branched or ring structure. Examples thereof include a fluoromethyl group, a trifluoromethyl group, a bromodifluoromethyl group, a 2-chloroethyl group, a 2-bromoethyl group, a 1,1-difluoroethyl group, a 2,2,2-trifluoroethyl group, a 1,1,2,2-tetrafluoroethyl group, a 2-chloro-1,1,2-trifluoroethyl group, a pentafluoroethyl group, a 3-bromopropyl group, a 2,2,3,3-tetrafluoropropyl group, a 1,1,2,3,3,3-hexafluoropropyl group, a 1,1,1,3,3,3-hexafluoropropan-2-yl group, a 3-bromo-2-methylpropyl group, a 2,2,3,3-tetrafluorocyclopropyl group, a 4-bromobutyl group, a perfluoropentyl group, and a perfluorocyclopentyl group.

Examples of the C₆₋₁₀ aryl group include a phenyl group, a tolyl group, a xylyl group, and a naphthyl group.

In Formula [3], Ar is a bivalent organic group of Formula [4] or [5]:

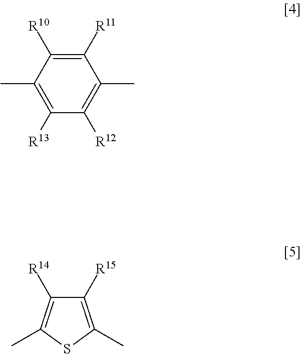

In Formulae [4] and [5], R¹⁰ to R¹⁵ are each independently a hydrogen atom, a C₁₋₁₀ alkyl group optionally having a substituent, or a C₆₋₁₀ aryl group optionally having a substituent.

Examples of the C₁₋₁₀ alkyl group, the C₆₄₀ aryl group, and the substituent include the C₁₋₁₀ alkyl groups, the C₆₋₁₀ aryl groups, and the substituents that are exemplified in the descriptions of R² and R³.

In the composition of the present invention, the content of the organic nonlinear optical compound is typically 1 to 150 parts by mass and preferably 10 to 100 parts by mass per 100 parts by mass of the norbornene imide polymer having the structural unit of Formula [1].

When the content of the organic nonlinear optical compound is 1 part by mass or more, sufficient nonlinear optical effects are likely to be obtained. When the content is 150 parts by mass or less, the organic nonlinear optical compound is easily formed into a film and the mechanical strength of the material is unlikely to decrease.

<Composition and Varnish>

When used as a nonlinear optical material, the composition of the present invention is generally used in a form of a thin film. A wet application method is preferable as a method for manufacturing the thin film. The wet application method includes the following steps. The composition of the present invention is dissolved in an appropriate organic solvent to be a varnish form. The varnish is applied on an appropriate base such as a substrate (a silicon/silicon dioxide coated substrate, a silicon nitride substrate, a substrate coated with a metal such as aluminum, molybdenum, or chromium, a glass substrate, a quartz substrate, or an ITO substrate, for example) or a film (a resin film such as a triacetylcellulose film, a polyester film, or an acrylic film, for example) by spin coating, flow coating, roll coating, slit coating, slit coating followed by spin coating, ink jet coating, printing, or other methods.

The solvent to be used in the varnish preparation is a solvent that dissolves the norbornene imide polymer having the structural unit of Formula [1], the organic nonlinear optical compound, and additives to be described later that are added if needed. The type and the structure of the solvent are not particularly limited so long as the solvent has such solubility.

Preferable examples of the organic solvent include tetrahydrofuran, a methyltetrahydrofuran, 1,4-dioxane, diethylene glycol dimethyl ether, methyl ethyl ketone, cyclopentanone, cyclohexanone, ethyl acetate, cyclohexanol, 1,2-dichloroethane, chloroform, toluene, chlorobenzene, a xylene, N,N-dimethylformamide, N,N-dimethylacetamide, dimethyl sulfoxide, chlorobenzene, and propylene glycol methyl ether. These solvents may be used alone or two or more of them may be used in combination.

Among the solvents, cyclopentanone, 1,2-dichloroethane, and chloroform, for example, are preferable in view of high solubility of the norbornene imide polymer having the structural unit of Formula [1] and favorable coating performance.

The solid content in the varnish is, for example, 0.5% by mass to 30% by mass or, for example, 5% by mass to 30% by mass. The solid content herein means a mass of a residue obtained by removing the solvent from the varnish.

Thus prepared varnish is preferably used after being filtrated through a filter having a pore diameter of about 0.2 μm.

The varnish can contain an antioxidant such as hydroquinone, an ultraviolet absorber such as benzophenone, a silicone oil, a rheology modifier such as a surfactant, an adhesion auxiliary agent such as a silane coupling agent, a cross-linking agent for a polymer matrix, a compatibilizing agent, a hardening agent, a pigment, a storage stabilizer, and an antifoaming agent, as needed, unless the effects of the present invention are impaired.

<Electro-Optical Element and Optical Switching Element>

The composition of the present invention is applicable as a material for various types of electro-optical elements that have been disclosed.

Examples of typical electro-optical elements include optical switching elements (optical communication elements) such as Mach-Zehnder optical modulators. In the optical switching elements, the composition of the present invention is applied on a base such as glass or a plastic. The composition applied on the base is processed by, for example, lithography with light or an electron beam, wet or dry etching, or a nanoimprint method, thereby having an optical waveguide structure through which light is transmittable. An optical waveguide structure is typically formed by applying and stacking a composition onto a material whose refractive index is smaller than that of the composition. The composition of the present invention is, however, not limited to this structure and also applicable to other optical waveguide structures.

In the Mach-Zehnder optical modulator as a typical optical switching element, a high frequency voltage is applied to both or one of the branched optical waveguide structures to cause electro-optic characteristics to emerge, whereby the refractive index is changed. This causes the phase variation of light propagated. Through this phase variation, the intensity of light after branched or multiplexed is changed, which enables high-speed light modulation.

The electro-optical elements herein are not limited to applications for phase modulation and intensity modulation and can be used for, for example, polarization conversion elements and multiplexing/demultiplexing elements.

Furthermore, the composition of the present invention can be used for, besides applications for communication elements, applications for, for example, electric field sensors that detect a change in an electric field as a change in a refractive index.

<Organic Nonlinear Optical Material>

In the present invention, a poling treatment is required to cause the second-order nonlinear optical characteristics of a material (thin film, for example) produced using the composition to emerge. The poling treatment is an operation including the following steps. A given electric field is applied to a material in a state where the material is heated to a temperature ranging from a temperature about 25° C. lower, preferably a temperature about 10° C. lower than the glass transition temperature of the material, to a temperature equal to or lower than the melting point. The material is then cooled down while the electric field is maintained, whereby the molecules of the nonlinear optical compound are oriented. This operation allows the emergence of macroscopic nonlinear optical characteristics of the material.

Also in the present invention, in the composition simply formed into a thin film, the molecules of the nonlinear optical compound are randomly orientated. Thus, the composition containing the norbornene imide polymer as a matrix and the organic nonlinear optical compound is heated to a temperature ranging from a temperature about 25° C. lower, preferably a temperature about 10° C. lower than the glass transition temperature of the composition (from 120° C. when the composition shows no glass transition temperature) to a temperature equal to or lower than the melting point. The resultant composition is subjected to a poling treatment, leading to emergence of nonlinear optical characteristics.

### EXAMPLES

The present invention will be described in further detail with reference to examples below but is not limited to the examples. The following are measurement apparatuses and the like used in the examples.

(1) GPC (Gel Permeation Chromatography)

Apparatus: LC-2000 manufactured by MASCO Corporation

Column: Shodex (registered trademark) GPC K-804L & K-805L manufactured by Showa Denko K. K.

Solvent: chloroform

Detector: UV (254 nm)

Calibration curve: standard polystyrene

(2)¹H NMR Spectrum

Apparatus: JNM-LA400 manufactured by JEOL Ltd.

Solvent: CDCl₃

Internal standard: tetramethylsilane (0.00 ppm)

(3) Differential Scanning Calorimeter

Apparatus: DSC 6220 manufactured by SII NanoTechnology Inc,

Measurement condition: under nitrogen atmosphere

Temperature elevation rate: 10° C./min (30° C.-270° C.)

### Synthesis of Norbornene Imide Polymer

### Synthesis Example 1

### Synthesis of Exo-norbornene-5,6-dicarboxylic anhydride[7]

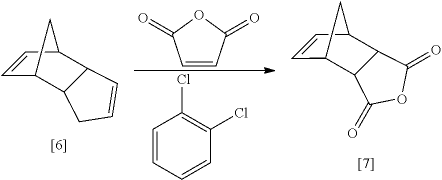

94.1 g (0.96 mol) of maleic anhydride [manufactured by Tokyo Chemical Industry Co., Ltd.] was dissolved into 100 mL of o-dichlorobenzene. 63.4 g (0.48 mol) of dicyclopentadiene [manufactured by Tokyo Chemical Industry Co., Ltd.] was added dropwise to the resultant solution at 173° C. Subsequently, this solution was refluxed at 183° C. for 1.5 hours and then was cooled down to room temperature. After the completion of the reaction, the reaction solution was left to stand overnight to precipitate crystals. Thus obtained grayish white solid was isolated through filtration under reduced pressure. The resultant compound was recrystallized from chlorobenzene twice.

The resultant compound was a mixture of an endo form and an exo form. The compound was heated at 250° C. under nitrogen atmosphere for 1 hour and was isomerized from the endo form to the exo form. The resultant compound was cooled down to 120° C. Chlorobenzene was added thereto, and the resultant mixture was sufficiently stirred to be uniform. The resultant mixture was then cooled down to room temperature, whereby a crystal of the exo form was precipitated. The precipitated white crystalline solid was filtrated under reduced pressure and the residue was washed with hexane. The resultant residue was dried in a vacuum at 60° C. to produce exo-norbornene-5,6-dicarboxylic anhydride (yield: 80%).

### Synthesis Example 2

### Synthesis of n-Cyclohexylamine Acid [8]

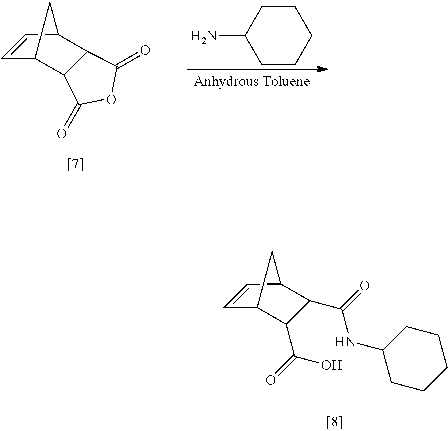 [SMILES: O=C1OC(=O)C2C3C=CC(C3)C12 ; NC1CCCCC1 ; O=C(O)C1C2C=CC(C2)C1C(=O)NC1CCCCC1]

100 g (0.61 mol) of the exo-norbornene-5,6-dicarboxylic anhydride produced in Synthesis Example 1 was dissolved in 200 mL of toluene. While the resultant solution was stirred, 60.9 g (0.61 mol) of cyclohexylamine [manufactured by Tokyo Chemical Industry Co., Ltd.] was added dropwise to the solution, and the resultant mixture was heated at 50° C. for 1 hour. Precipitation occurred 20 minutes later, and the viscosity of the solution increased due to the formed precipitate, and thus, toluene was added in a small amount. The precipitate was then filtrated, and the residue was washed with extra toluene to produce an n-cyclohexylamine acid (yield: 72%).

### Synthesis Example 3

### Synthesis of N-Cyclohexyl-exo-norbornene-5,6-dicarboximide[9]

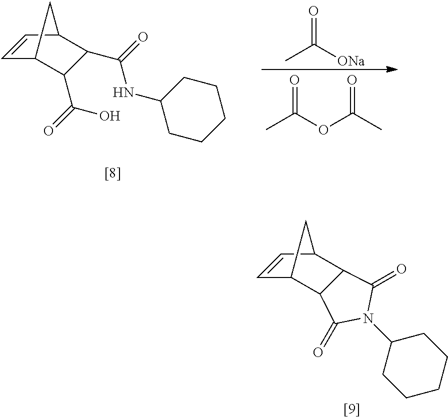

26.6 g (0.10 mol) of the n-cyclohexylamine acid produced in Synthesis Example 2 and 4.7 g (57 mmol) of sodium acetate anhydrous [manufactured by KANTO CHEMICAL CO., INC] were dissolved in 94.3 g (0.92 mol) of acetic anhydride [manufactured by KANTO CHEMICAL CO., INC]. The resultant solution was refluxed at 140° C. for 2 hours. The resultant reaction solution was then put in a freezer for complete solidification.

The solid, as filtrated and was washed with ion-exchanged water in an excess amount. The water phase of the filtrate was subjected to extraction with chloroform, and the solvent was distilled off. The resultant solid was combined with the filtrated solid. The grayish white solid was dried overnight under reduced pressure at 60° C. Subsequently, the solid was recrystallized from methanol several times until it turned white to produce N-cyclohexyl-exo-norbornene-5,6-dicarboximide (yield: 65%). The produced compound had sublimability at 150° C.

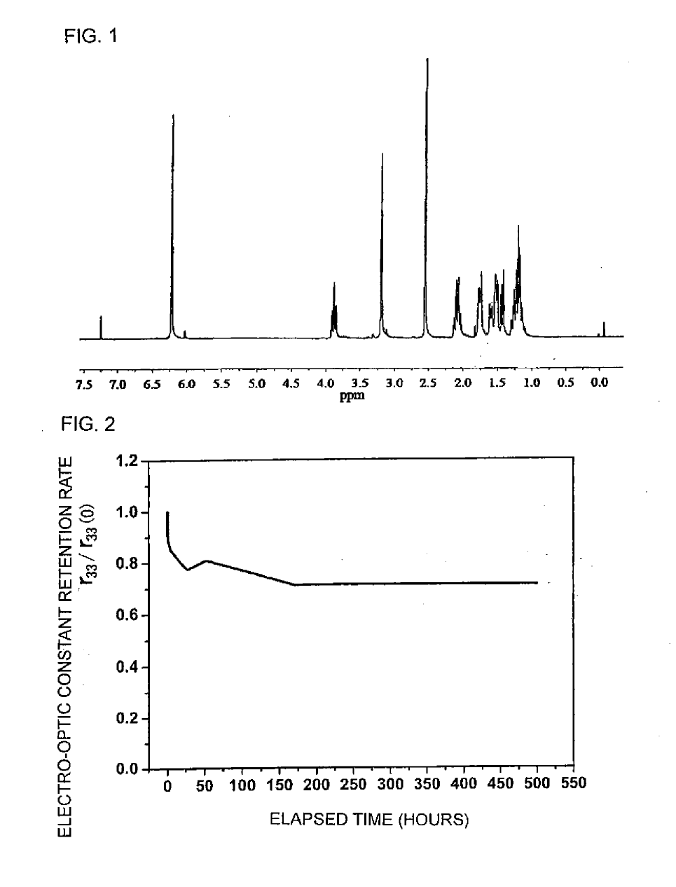

FIG. 1 shows a ¹H NMR spectrum of the produced compound.

### Synthesis Example 4

### Polymerization of N-Cyclohexyl-exo-norbornene-5,6-dicarboximide[9]

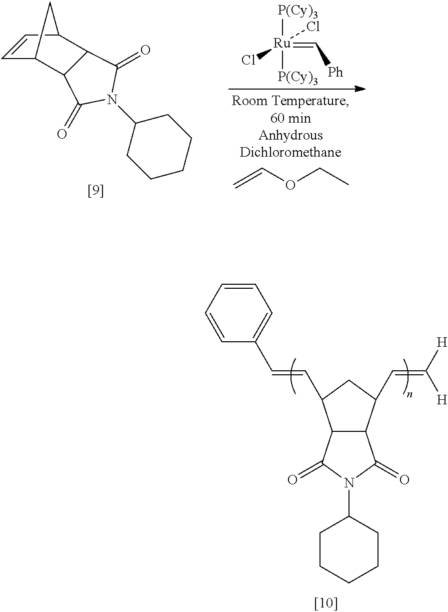

0.5 g (2 mmol) of the N-cyclohexyl-exo-norbornene-5,6-dicarboximide produced in Synthesis Example 3 was dissolved in 10 mL of dichloromethane anhydrous under nitrogen atmosphere. The resultant solution was stirred at room temperature for 10 minutes. To this solution, a solution in which 17 mg (2.04×10⁻⁵ mol) of the first generation Grubbs' catalyst [manufactured by Sigma-Aldrich Co. LLC.] had been dissolved in 0.5 mL of dichloromethane was added in small portions. This reaction solution was stirred at room temperature for 1 hour. Subsequently, polymerization was stopped by adding 2 mL of ethyl vinyl ether. This reaction mixture was added to methanol to precipitate a polymer. The precipitate separated through filtration was further reprecipitated from chloroform-methanol twice, and the resultant precipitate was dried overnight under reduced pressure at 60° C. to produce a norbornene imide polymer A (yield: 94%) as a target product.

The weight-average molecular weight Mw and the polydispersity Mw/Mn (number-average molecular weight) of the produced norbornene imide polymer A were 28,000 and 1.1, respectively, which were measured by GPC in terms of polystyrene.

### Synthesis Example 5

### Polymerization 2 of N-cyclohexyl-exo-norbornene-5,6-dicarboximide[9]

An operation was performed in a manner similar to that of Synthesis Example 4 except that the amount of the first generation Grubbs' catalyst used was changed to 2.8 mg (3.39×10⁻⁶ mol) to produce a norbornene imide polymer B (yield: 90%) as a target product.

The weight-average molecular weight Mw and the polydispersity Mw/Mn of the produced norbornene imide polymer B were 147,000 and 1.1, respectively, which were measured by GPC in terms of polystyrene.

### REFERENCE EXAMPLE

### Synthesis of Nonlinear Optical Compound

As a nonlinear optical compound to be introduced in a polymer, Compound [11] below was used. This compound was synthesized in a manner similar to that described in X. Zhang, et al., Tetrahedron. lett., 51, p. 5823 (2010).

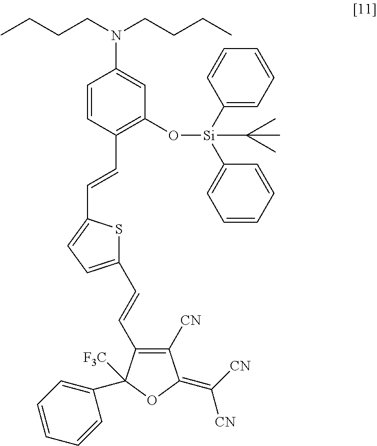 [SMILES: CCCCN(CCCC)c1ccc(/C=C/c2ccc(/C=C/C3=C(C#N)C(=C(C#N)C#N)OC3(c3ccccc3)C(F)(F)F)s2)c(O[Si](c2ccccc2)(c2ccccc2)C(C)(C)C)c1]

### Example 1

### Measurement of Glass Transition Temperature

The glass transition temperatures of samples were measured by a differential scanning calorimeter. The samples were the synthesized norbornene imide polymers A and B, and the synthesized norbornene imide polymers A and B each mixed with 50 parts by mass of the nonlinear optical compound indicated in Reference Example per 100 parts by mass of the polymer. Table 1 lists the obtained result.

TABLE 1

| | Glass transition temperature |
|---|---|
| Sample | [° C.] |
| Norbornene imide polymer A | 208.4 |
| Norbornene imide polymer B | 223.4 |
| Norbornene imide polymer A + nonlinear | 161.0 |
| optical compound | |
| Norbornene imide polymer B + nonlinear | Not observed |
| optical compound | |

### Example 2

### Measurement of Electro-Optic Constant

60 mg of the norbornene imide polymer A(B) and 30 mg of the nonlinear optical compound synthesized in Reference Example were mixed into a mixed solvent of 1 mL of deuterated chloroform and 1 mL of 1,2-dichloroethane. The resultant mixture was stirred at 50° C. for 1 hour.

The stirred solution was filtrated through a filter having a pore diameter of 0.20 μm, and then, an ITO substrate was spin coated with the filtrate. This sample was baked in an oven in a vacuum at 120° C. for 24 hours and was formed into a polymer thin film. Thereon, a film of gold, having a thickness of 100 nm, was formed by sputtering to serve as an upper electrode.

Commercial poly(methyl methacrylate) (PMMA) [manufactured by Wako Pure Chemical Industries, Ltd.] was used as a matrix polymer for comparison, and a measurement sample was produced in a similar manner.

The electro-optic constants of the produced samples were measured using a semiconductor laser having a wavelength of 1.31 μm as a light source, in a manner similar to that described in C. C. Teng et al., Appl. Phys. Lett. 56, p. 1734 (1990) and Y. Shuto et al., J. Appl. Phys. 77, p. 4632 (1995). Table 2 lists the value of the electro-optic constant r₃₃ obtained from each of the samples, together with the temperature and the application voltage at which the electric field orientation treatment was performed, and the film thickness of the sample. With PMMA, when the nonlinear optical compound concentration (the concentration of the nonlinear optical compound in the mixture of the matrix polymer and the nonlinear optical compound) was 25% by mass or more, the electro-optic constant decreased due to flocculation of the nonlinear optical compound. In contrast, with the norbornene imide polymers A and B, the nonlinear optical compound concentrations were each 33% by mass, indicating large electro-optic constants.

TABLE 2

| | Nonlinear | | | | |
|---|---|---|---|---|---|
| | optical | | | | |
| | compound | | | Film | Electro-optic |
| | concentration | Temperature | Application | thickness | constant |
| Sample | [% by mass] | [° C.] | voltage [V] | [μm] | r₃₃ [pm/V] |
| Norbornene | 33 | 137 | 200 | 1.2 | 93 |
| imide polymer | | | | | |
| A | | | | | |
| Norbornene | 33 | 155 | 150 | 1.5 | 82 |
| imide polymer | | | | | |
| B | | | | | |
| PMMA | 25 | 98 | 200 | 2.5 | 54 |

### Example 3

### Temperature Endurance Test

A temperature endurance test was performed on the samples the electro-optic constants of which had been measured in Example 2. While the samples were each maintained at 85° C., relaxation characteristics of the electro-optic constant was measured from the time immediately after poling to 500 hours later. FIG. 2 shows the rate of change (r₃₃/r₃₃ (0)) of the electro-optic constant r₃₃ of the norbornene imide polymer B from the initial value (r₃₃ (0)) as a function of time.

It is generally known that in the use of PMMA as a matrix polymer in the above condition, the retention rate decreases to nearly 0% in a few hours. However, with the norbornene imide polymer B of the present invention, 70% of the initial value was retained after 500 hours had passed. Specifically, it is apparent that the use of the norbornene imide polymer B greatly suppressed the orientational relaxation of the nonlinear optical compound.

1. A composition comprising:
a norbornene imide polymer having a structural unit of Formula [1]; and
an organic nonlinear optical compound: 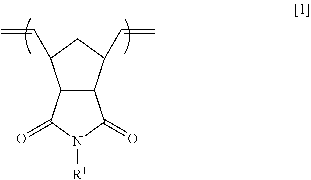
(where R¹ is a C₁₋₁₂ alkyl group optionally having a substituent or a C₆₋₁₀ aryl group optionally having a substituent).

2. The composition according to claim 1, wherein
the organic nonlinear optical compound is a compound having a furan ring of Formula [2]: 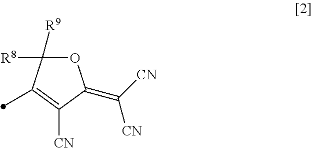
(where R⁸ and R⁹ are each independently a hydrogen atom, a C₁₋₅ alkyl group, a C₁₋₅ haloalkyl group, or a C₆₋₁₀ aryl group; and • is a bond).

3. The composition according to claim 2, wherein
the organic nonlinear optical compound is a compound of Formula [3]: 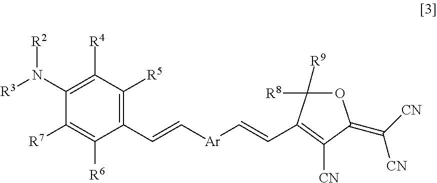
(where R² and R³ are each independently a hydrogen atom, a C₁₋₁₀ alkyl group optionally having a substituent, or a C₆₋₁₀ aryl group optionally having a substituent; R⁴ to R⁷ are each independently a hydrogen atom, a C₁₋₁₀ alkyl group, a hydroxy group, a C₁₋₁₀ alkoxy group, a C₂₋₁₁ alkylcarbonyloxy group, a C₄₋₁₀ aryloxy group, a C₅₋₁₁ arylcarbonyloxy group, a silyloxy group having a C₁₋₆ alkyl group and/or a phenyl group, or a halogen atom; R⁸ and R⁹ are each independently a hydrogen atom, a C₁₋₅ alkyl group, a C₁₋₅ haloalkyl group, or a C₆₋₁₀ aryl group; and Ar is a bivalent organic group of Formula [4] or [5]: 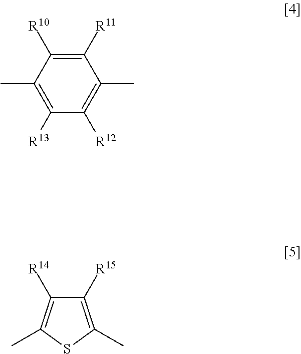
(where R¹⁰ to R¹⁵ are each independently a hydrogen atom, a C₁₋₁₀ alkyl group optionally having a substituent, or a C₆₋₁₀ aryl group optionally having a substituent)).

4. The composition according to claim 1, wherein
the content of the organic nonlinear optical compound is 1 to 150 parts by mass per 100 parts by mass of the norbornene imide polymer.

5. A varnish comprising:
the composition as claimed in claim 1.

6. A thin film made from the varnish as claimed in claim 5.

7. An electro-optical element comprising:
the composition as claimed in claim 1.

8. An optical switching element comprising:
the composition as claimed in claim 1.

9. An organic nonlinear optical material comprising:
the composition as claimed in claim 1.
